(19) United States
(12) Patent Application Publication
(10) Pub. No.: US 2019/0184285 A1
(43) Pub. Date: Jun. 20, 2019

(54) GAME SYSTEMS AND METHODS

(71) Applicant: Thinkrite, Inc., Ft. Lauderdale, FL (US)

(72) Inventor: Joshua Schrager, Ft. Lauderdale, FL (US)

(21) Appl. No.: 15/846,326

(22) Filed: Dec. 19, 2017

(51) Int. Cl. A63F 13/40; A63F 13/213; A63F 13/95; A63F 13/79; A63F 13/335; G06Q 10/06

(52) U.S. Cl. CPC A63F 13/40; A63F 13/213; G06Q 10/063; A63F 13/79; A63F 13/335; A63F 13/95

(57) ABSTRACT

The present invention relates to game systems and methods which provides game objects having machine readable devices which are not easily read by a human player and information meant to be read by the human players. The game system allows each player to respond by placing the game objects down while responding anonymously to the next question/response/action requested in the game. The game objects can be placed in relative positions to each other, and the plurality of machine readable devices read simultaneously to allow use of the information provided by the game object and/or its relative position to other game objects. A game platform may be provided to facilitate access to, customization or other processes to be implemented by a user.

### FIELD OF THE INVENTION

The present invention relates to games for use in many applications including business management, business planning, innovation and development, entertainment or many more business or personal applications.

### BACKGROUND OF THE INVENTION

Relationships among members of a network are important for many reasons, such as production and efficiency in the business setting, or growth and emotional attachment in a personal setting. For example, business executives or managers are interested in the efficiency and success of a particular network of personnel. To facilitate this, they in turn are concerned with monitoring and improving social relationships so as to optimize performance on the part of individuals and the entire network. Traditional techniques for monitoring an individual performance or social relationships in a business environment rely on manual and electronic data collection, such as using questionnaires, interviews, observations, and self-assessment surveys for example. Such tools may be inaccurate or unreliable, as individuals may not be incentivized to be candid and objective. A need exists for improved data gathering and interpretation techniques that can effectively characterize the interactions between and among individuals and groups or an individual performance for example, provide motivation or problem solving assistance, or for other purposes.

In a personal capacity, various tools or inventories have been developed to help a person determine their behavioral characteristics, and/or to modify current characteristics or achieve new characteristics that are beneficial to their personal growth. There is a desire to enhance personal characteristics such as a person's creativity, analytical ability, risk taking level, or others. There is a need for tools to promote such desires.

There is also the need for entertainment, and games of all types have been developed, including a wide variety of card games. There is a need for enhancement of game types and player interactions to provide unique entertainment to an individual or group.

### SUMMARY

In an aspect of the invention, there is provided a tool in a game format and methods, that uses computer aided image processing on the game objects, such as cards or other suitable objects, to identify player's responses for a variety of purposes. The game type tool and methods provides suitable mechanisms to allow a player to make a selection in response to an action event in a game. The action events can be any step of the game or method requiring action by a player, who then can use a game object to take an action in response. For example, the mechanisms may be a plurality of statements to which one or more individuals respond by indicating his or her degree of agreement or disagreement with the statement, the selection of a preferred statement or many other purposes. The responses of the player(s) are determined by use of an electronic device to image the one or more game objects representing response(s), which will be interpreted by computer. This allows the detail of the response(s) from the one or more players to be electronically determined and/or revealed to one or more players.

In an aspect of the invention, there is provided a tool in a game format and methods, that is useful in a business environment to allow progress toward or achieving a desired goal or objective. In a business environment, the relationships among members of a network or team are important for many reasons, such as production and efficiency. The invention can facilitate achieving better performance, fostering innovation, increasing motivation, or many other objectives.

In an aspect of the invention, the invention provides a tool in a game format and methods for monitoring and improving social relationships so as to optimize performance on the part of individuals and/or an entire team for example.

In an aspect of the invention, the invention also provides a tool and methods for improved data gathering and interpretation to achieve the desired objectives. In an example, the tool can effectively characterize the interactions between and among individuals and groups.

In another aspect of the invention, there is provided a tool in a game format and methods, that can be used by a group to allow progress toward or achieving desired goals or objectives, both professionally or in a personal sense.

In an aspect of the invention, the invention provides a tool in a game format and methods for interaction between individuals to contribute to being helpful in making a person aware of particular personality characteristics, and/or strengths and weaknesses associated with the personality characteristics, or to facilitate achieving success for a particular individual or organization. For example, the tool may contribute to identifying different orientations or individuals that can be useful in understanding the differences among people within work groups. For example, to contribute to planning, decision making, and problem solving, etc., to develop a clearer perception of the group's resources or deficiencies.

In a further aspect of the invention, there is provided a tool in a game format and methods useful in career-counseling and career-development efforts, in team building, enhancing one's self-understanding and in changing an organization's culture or performance or data to qualitatively measure other characteristics of individuals or organizations.

In another aspect, examples provide a game system and methods comprising a one or more game objects for use in playing the game, which can be in the form of cards or other objects to allow participation by individuals. At least some of the game objects comprise at least one image that is a unique identifying element. By way of example and not limitation, the unique identifying element may be a QR code, RFID tag, embedded computer chip, or any other device/image that allows an image or information capture device to read it, such as a handheld electronic device, to either visually or electromagnetically identify a game object and possibly its relative position, orientation direction or the like in relation to itself or to the other game objects in two or three dimensional space.

In another aspect of the invention, there is provided a game for entertainment wherein a plurality of game objects include one or more images readable by computer aided image processing, such as cards or other suitable objects, that are selected and used by players of the game to identify player's responses for determining an outcome in response to an action event in a game. The game objects allow a player to make a selection in response to an action event, wherein the action events can be any step of the game or method requiring action by a player. The game objects to respond to the action event are selected and one or more of the objects are imaged by a suitable device, to allow the images readable by computer aided image processing to be determined.

The foregoing is not intended to be an exhaustive list of embodiments, examples and/or features of the present invention. Persons skilled in the art are capable of appreciating other embodiments and features from the following detailed description of examples in conjunction with the drawings.

### DESCRIPTION OF THE DRAWINGS

FIGS. 1A and 1B show an example of a game object used in a game system of the invention.

FIG. 2 shows an example game system of the invention.

FIG. 3 shows and example game system platform according to the invention.

FIGS. 4A and 4B show a mounting system for positioning of a reading device for reading one or more machine readable devices associated with one or more game objects in the game system.

### DESCRIPTION OF EXAMPLES

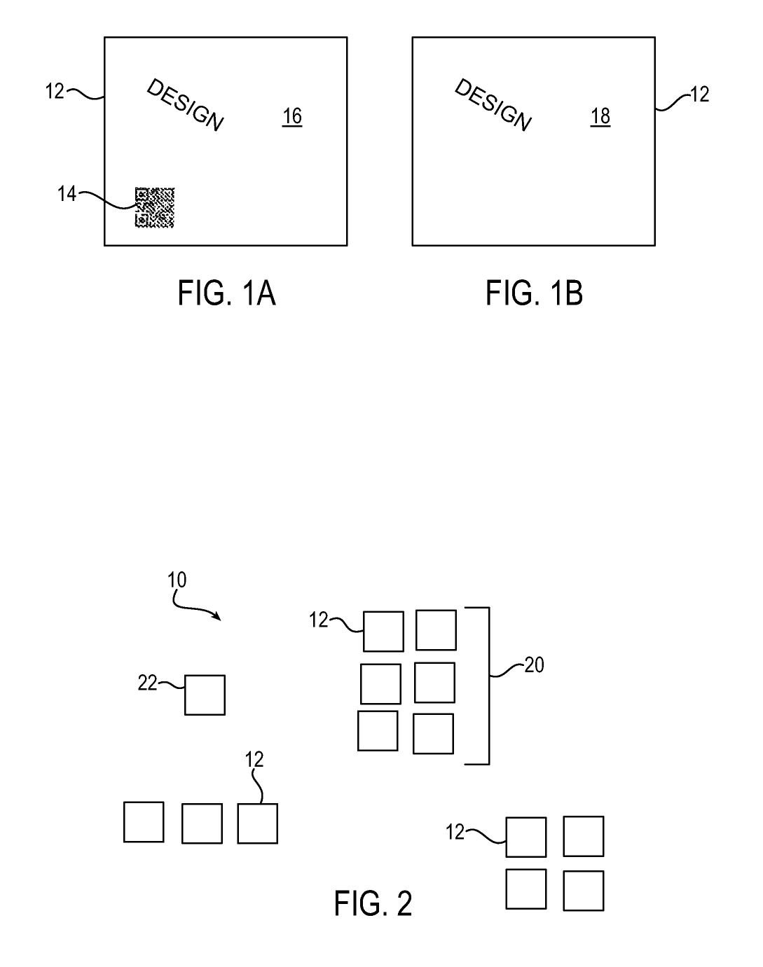

In an example, FIGS. 1A and 1B show an example game object 12 provided in association with a game system 10 of the invention, such as comprising a plurality of game objects shown in FIG. 2. A game object 12, such as a card, includes a computer readable indicator device 14 on a side. In an example, the “face down” side 16 of the game object such as a card 12 shown in FIG. 1A includes a machine readable device or graphic 14 that can be interpreted by computer, and which is not easily read by a human player. The “face up” side 18 of the game object 12 may include graphics meant to be read or interpreted by the human players, or other information. The game objects 12 may have printed materials and/or could use a suitable display or communication technology to allow the game system 10 to communicate and/or display information to the players via the game objects 12. For example, the game objects 12 could include an e ink display that communicates wirelessly with a computer and/or the internet to allow customized graphic information to be sent to and displayed on the game object 12.

In an example, the machine readable device 14 may be a barcode, QR code, RFID tag, embedded computer transmitter and/or receiver chip, or any other device that allows “reading” by a machine. For example, the device 14 may be a QR code that can be imaged using a handheld electronic device such as a smart phone, tablet or the like. The image is processed to reveal game information and the players response or action, that is usable by the game system 10. The device 14 may be either visual, electromagnetic or other suitable mechanism to identify an object 12 and the information associated therewith. This may include a wireless communication system that allows the selected game object to be “read” the game object 12. The game object data can be incorporated into a memory unit, stored and accessed via the internet or cloud computing system, or in any other suitable manner, and data from the game object transmitted over a network or in any other suitable manner, and may allow for viewing of the game information on a display device or other manner for example.

In an example, players may use an electronic device such as a smart phone to take pictures of one or more face down cards having a QR code or the like, which will be interpreted by computer. Thus, allowing the detail of the responses from one or more players to be electronically tabulated, revealed (such as to selected players) or otherwise handled. The game objects 12 and machine readable device(s) 14 allow each player to use the game objects 12 to respond to an action event in the game 10 by placing the object 12 down in front of the other players. This provides the player the ability to respond, but without revealing their actions to the other players, and optionally anonymously not revealing their identity. This will allow players to hide their responses and optionally their identity by having to turn the cards face up side to the other players. The game system 10 allows players to have a physical interactive game that allows information or other data for response to action events to be used, gathered, processed or otherwise handled. In a personal or business context, this could be used for either coaching, ideation, training, planning, evaluation or many other activities or objectives. The responses all get processed in the background and no player really knows whose cards are whose, thereby providing anonymity. For many types of games, the game system 10 allows a player to give input without feeling like they are under scrutiny from others as to what their input is. In the world of computers, it has become increasingly hard to protect someone's anonymity because of the distinct possibility or based on a person's suspicion, that something is going to be traced back to the person or somebody is going to find the disclosed information out. In an example of a game system, a card deck allows players to respond anonymously because the cards are typically shuffled and distributed in a manner that other players do not know what the other players have. The game can be conducted such that a player's responses are anonymous, and other players nor even others such as management, are not aware of who is responding to what. In further anonymizing the game system 10, any identification information associated with a reading device, such as a smart phone used to take a picture of the machine readable device 14, may be scrubbed or otherwise not made available after processing of the machine readable device 14.

In a further example, such as shown in FIG. 2, the players may place the objects 12 down in a specific order or relationship to other objects 12, wherein the relative position to the other objects 12, such as shown at 20, is used by the game system 10 for determining game steps, gathering game data, or a variety of other purposes. A player may read multiple machine readable devices 14 together, such as by taking an image that contains plural computer readable codes, which can then be processed to recognize attributes of the game or the players, such as the player's intent based on the relative position of an object 12 placed by a player in proximity or relationship to the other objects. The objects 12 placed down in a specific proximity, order or relationship to other objects 12 are all imaged or otherwise read together, wherein the relative position to the other objects 12 may cause predetermined events or actions in the game system 10, such as additional action items, data gathering or processing, or any other type of use for implementation of the game.

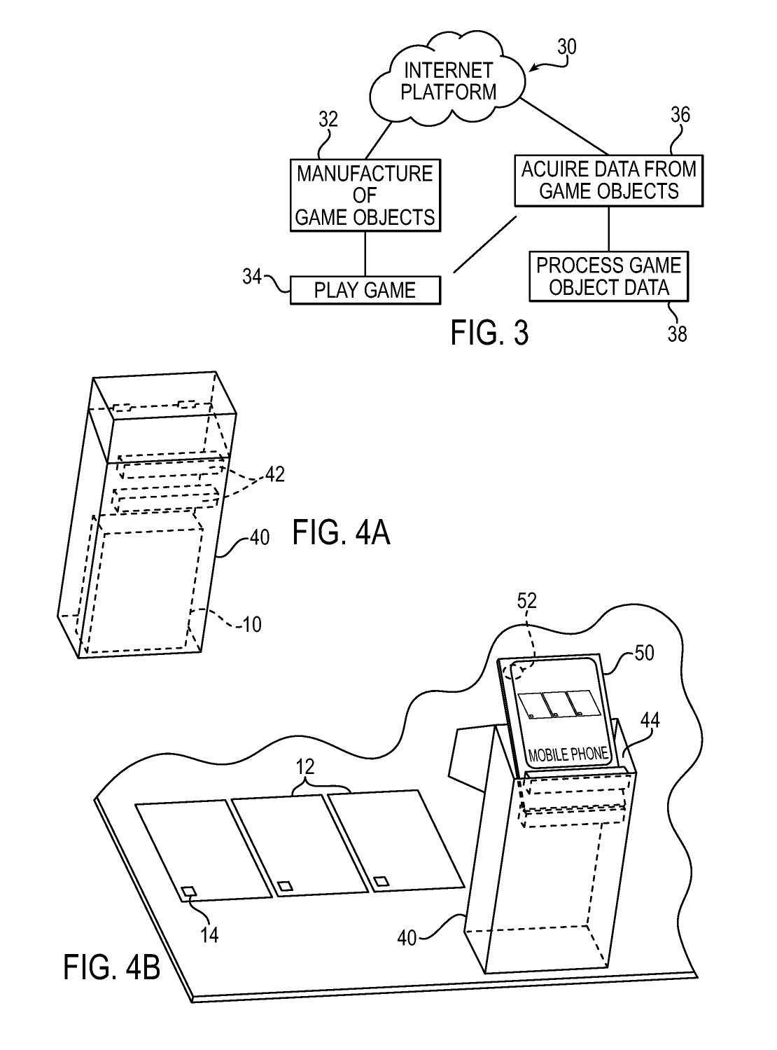

The game objects 12 may be provided with a game system, or a user could be authorized to manufacture the game objects 12 such as by printing where the game objects are cards for example. This may allow providing the game system via an internet platform, which could then be used to customize a game system for a particular user, such as a company. The ability to print or otherwise produce (such as by 3D printing) game objects 12 dynamically by a company for a workshop or the like opens up many possible game systems tailored for use by a particular user or for a particular purpose that is customized to the user. The game objects 12 may be produced with the machine readable device 14 provided on one side 16 of the produced cards or the like. The other side 18 of the card 12 may be provided with one or more questions, responses, actions, or the like, to facilitate use in the game system 10. As an example as shown in FIG. 3, such a platform 30 may provide users with the ability to custom print (or otherwise produce) game objects 12 with machine readable devices 14 such as custom QR codes at their site, such as at 32. The platform 30 could be provided via the internet, intranet or otherwise. The game objects 12 are used to play the game system 10 at 34. During the playing of the game, the machine readable devices 14 of the game objects 12 are read and data acquired at 36. The acquired game object data may be processed by the user via a software application provided with the game system or in another suitable manner at 38. Alternatively, the game object information could be communicated to the platform 30 for processing and response to the user via The platform may be populated with different predetermined game types, game actions, game questions or sample responses that may be used in a game, or the like. The user (i.e., a company) could then upload particular game types, game actions, game questions or sample responses that may be used in a game, or the like, and additionally put in graphics that will appear on the printed game objects 12, such as their own brand on the game system 10. The platform 30 may include pre-created games and in addition to that, could offer the user a service where they can go in and build their own game. Such game creation may include the users content, and may also include pre-created images and structures provided to the user. The game system 10 may also be offered via multiplayer video gaming systems with game objects 12 being integrated into the video game scenario. Such scenarios may include role playing games for example, with game objects 12 used interactively to accomplish tasks or cause other actions in the video game. Using the platform 30, users can build games in different languages, could build them for different purposes and sell their own games along with an app supplied by the platform 30 or otherwise, that interfaces with the developed game. For a card type game system 10 such as described in examples, the platform 30 may provide for custom printing and custom QR codes for game creation. The different pre-created games types that may be provided via platform 30 can allow users to upload a particular question, answer or the like, and put in graphics or other information, along with the machine readable device that will appear on the game objects.

In another example of a game system 10, there may be provided one or more start or control game objects 22 as shown in FIG. 2, to facilitate playing the game. For example, one or each player can start their game by reading the start/control object 22, such as by taking a picture of the start/control object 22 and machine readable device 14 associated therewith. This image is processed locally via an app associated with the game system employed on a computer, smart phone, tablet or the like. The start/control object 22 may be used to individually or together identify the start of game play, specify the rules the game players have agreed to (e.g. anonymity), or produce other actions or events. The start/control object(s) 22 are used to affect some control variable in the game system 10. In another example, the start/control object(s) 22 may be used to trigger the actions or events such as the type of game, which questions or responses or other actions/events provided on the game objects 12 will be asked or used in a game, or for a variety of other purposes to facilitate game play. As a starter object 22, it could be scanned or read first and then it would be processed locally (38 in FIG. 3) or remotely (30 in FIG. 3), and create/cause further steps of that particular game session to begin. As an example, the game system 10 could be a package of cards, with a unique ID provided for that package of cards. A starter object 22 and associated machine readable device 14 could be provided on the outside cover or packaging for the deck of cards on a separate card or the like, such as by a QR code. A picture of the machine readable device 14 could initiate play of the game in association with an app on a computer or one or more smart phones, and turns on the app and says welcome to the game participants to begin the game or cause an action/event. Alternatively, there may be provided a plurality of decks of cards that are each specifically identified for use in a particular game system 10, such as designed for a number of players. Each player may be provided with their own deck, and own start/control object 22. Upon reading the machine readable device 14 associated with their own start/control object 22, and/or where each player reads the same control card, they're all registering for play of the game system 10 and they all automatically get registered to the same game. The use of one or more start/control objects 22 allows a wide variety of games to be played and customized, such as regarding the start of the game, the rules of the game, to whom and what information is communicated during the game, etc. The start/control objects 22 allow interface to the processor/computer that is then used at least in part to conduct steps of the game. The start/control objects 22 may be provided such that a set of steps will be played out via the interaction with the computer/processor, either locally or remotely.

As an example, a game system 10 could be implemented as a game for entertainment which a group of people. Numerous types of games could be implemented via the game system 10, with several examples being games like Cards Against Humanity®, Trivial Pursuits®, Mad Libs®, Jeopardy® and a wide variety of others or similar type nines. In such games, there are typically game objects such as cards with statements, questions, fill-ins, sample responses, or the like, which the payers use to play the game in conjunction with one another. The game system 10 could include game objects 12 and one or more starter/control game objects 22 to implement and control the game play. For example, using cards as the game objects 12, the players can take a picture of the machine readable device 14 such as a QR code with a phone, a tablet, a computer camera or the like. The players can kickoff game play using a starter game object 22. In games such as mentioned above, they may take a picture of the box or the specific starter card 22 that has instructions that this is the control card and take a picture of me first. Upon taking the picture, the image is automatically processed and can be used to open up an app on the phone, computer or the like. As soon as the app is launched, a number of games that the app has in its memory can be displayed, and this can be used to interact with the players, such as by audible, visual or other cues. The app could welcome the players to the game, and allow selection of the particular game to be played or the like. For example, games like Cards Against Humanity® may be configured to have different levels of questions/responses/fill-ins or the like to make it kid friendly or adult oriented, and the players can choose the level of game to be played. As noted previously for example, the game objects 12 could include an e ink or other display that communicates wirelessly with a computer and/or the internet to allow customized graphic information to be sent to and displayed on the game object 12. The correlation and details of how the game is implemented and how data is transmitted or received can be correlated through the app or a server based or centralized processor. It can happen on one of the local devices or in the cloud and be sent back. In addition to the starter/control game objects 22, during the game, additional steps might include taking additional pictures of cards (or otherwise reading the game objects 12) that are laid down during the game, which can be automatically processed, uploaded and used by the app to respond accordingly based on the game system 10 being implemented. The game system 10 may have wide variation and can be set up to interact with a player's on-line profile to be used for either identification, tracking of responses, providing results of the game or many other purposes.

In another example, such as for use by a company or business, as the game systems 10 can allow interaction between players while maintaining anonymity, the game system 10 could be used in the context of an in person meeting, such as a team within the company. The meeting may be directed to coaching, ideation, training, planning, evaluation or many other activities or objectives. For example, a problem solving session may be facilitated by a game system 10, where a team of people use the game system 10 to respond to questions, sample responses, fill-ins or the like. Inquiries such as “What's wrong with this project?”, “What are the things that would most help?”, “Our boss might improve his skills by _____”, “What are the things that I'm not talking about that I should be talking about?” or the like, with possible responses provided via the game objects 12. These cards could include responses like yes, no or I strongly agree/disagree, sample responses to inquiries or fill-ins or the like. It should be recognized that the specific game system 10 could include a wide variety of game objects 12 to allow different goals or objectives to be sought. Just one type of game system 10 could allow players to respond to computerized questions by putting down these cards or game objects 12 in rows face down on the table. A picture could then be taken of the played cards and multiple machine readable devices 14 thereon and processed to provide data or feedback to the group and/or individual. This allows a wide variety of applications for business or personal growth for example.

The responses of the player(s) are determined by use of an electronic device to image or read the one or more game objects 12 representing response(s), which will be interpreted by computer/processor. This allows the detail of the responses from the other players to be electronically determined, tabulated and/or revealed to one or more players. The result of the game could be used to compare information between players for the purposes of either providing feedback to a user or identifying a winner being a specific player without revealing who or how they have responded. Results may allow a player to compare their responses to the groups to determine how much of a difference there is between other opinions and how I view myself or an issue. For professional or personal growth for example, a player may be the subject of the game responses, and then they may be the only one that gets feedback from the game system 10, which might relate to issues like “Here's how I consider myself and here's what everybody else thought.” The game system 10 allows players to feel like they can source everyone's input because their using the same game system 10 that I am, and they can physically feel it, while providing anonymity. As should be evident, the game systems 10 can be customized to facilitate achieving a wide variety of business or personal goals and objectives.

As an example of a game system 10, a game system 10 may be referred to as the “Life Coach Game”. In the game system 10, the game objects 12 may be cards, with devices 14 such as QR codes on the face down portion of the cards. The objective of this playing card game is to allow each player to be the “Subject”. The group is asked to respond to the Questions of the Subject receive anonymous feedback from the group of players. The game system 10 of this example may provide that each player starts out with a unique deck of 48 answer cards in 4 color suites of 12 cards. The pack of cards may include a start/control object 22, to allow each player to sign in. On the face up side of the different colored card suites, there may be images and words, such as Red-Challenges, Green-Drives, Blue-Strengths and Yellow—Improvements. Each of the face down sides of the cards have a QR code and a color that players put down during play of the game so the QR code is visible. There may be 5 scenario or question cards with each of the colored card suites, such as including 4 color question scenarios, 2 on one side and 2 on the other, or 5 question cards for each color with 1-3 questions on them, and 4 colors that match them (20 Question Cards). A goal of the game may be for a player to see if they and the other player(s) will come up with the same answers, or if your own opinion is the same or different from the others answering the questions. Upon playing of the cards during a round in response to scenario or question cards, the Users take a picture of the 32 (or other plurality) played cards. Depending on the game, the cards may be grouped together and scanned or imaged in one picture from a mobile phone with all of the QR codes imaged and processed together, or the cards may be played in relative proximity to other cards and then those cards are imaged together. As an example, two players each answer questions about one of the players and each put down answers. As a further example, each player has 12 answer cards each, and can put down up to 4 cards to answer each question. The card with the closet answer placed down first and the next best placed to the right of the card or the like. A question may be: “Q1 What drives GREEN player 1” or “ Q2 4 RED challenges that best describe player 1. As a further example, each player can take turns being the Subject player and asking other players questions, by reading the 4 scenarios about themselves on that card. For example, a Blue Strength Scenario is asked “my company is coming out with a new product. What strengths can I bring to the project?” please place the top 4 greatest strengths side by side, with the right one rated as the highest one”. The responses by the players may then be individually or together imaged by taking a picture, with the QR codes then processed at a single time to gather data, provide feedback or the like. The results of the game can be correlated and shared with the other players if desired.

In this example, where the “face down” side of the object has a graphic computer code which is not easily read by a human player and the “face up” side of the object is meant to be read by the human players, each player can respond by placing the object face down in front of the other players while responding anonymously to the next action requested in the game. Players can place the objects 12 face down in relative importance or relationship given their relative position to the other objects 12. Players may use an electronic device to then take one or more pictures of multiple face down objects. Thus, allowing the detail of the responses from the other players to be electronically tabulated and\or revealed to selected players without needing to show the face up side to the other players.

The information communicated by the objects 12 may be based upon both the positioning of the objects 12 such as cards, as well as which objects 12 get put down. In the above example, the deck of cards may include various attributes that can be used to identify with one or more players. The game system 10 also allows game information to be captured and stored, such as inside the player's profile, a profile the game system 10, or the like. This could allow information such as in relation to every meeting that a person has, can get stored into this backend profile or the like. This allows user to get a composite of information, a historical record or the like. Such information may be used for a variety of purposes, such as to facilitate execution and analysis of a plan, such as a personal growth plan or the like, to be maintained and become part of the employee's personnel file, or a wide variety of other purposes.

As with the example above, the game system 10 may be directed to a system and method for interactively assessing at least one characteristic of an individual's personality and/or developing a personal growth plan and enable monitoring the individual's progress along that plan. The term “characteristic” can refer to a wide variety of traits, such as whether a person is approachable; competitive; confident; creative; open-minded; analytical and on and on. Existing tools available to businesses to assess personality may be integrated into the game system 10, such as the Myers-Briggs Type Indicator® or any other suitable tools for implementation of a game system and analysis. Such tools may be in the areas of clinical psychology tests, cognitive development test, intelligence tests, medical tests, self-tests, statistical tests, skills assessment tests, risk taking tests, innovation tests or any other suitable category of tool to allow an objective or result to be achieved. It is to be understood that the invention is not limited to use of any particular tools, but can be directed to affecting behavioral changes in individuals or groups. Other mechanisms can also be integrated such as personal/professional coaches to assist in implementation of a growth plan and monitoring the progress along that plan.

In the implementation of the game system 10, it is also possible to provide realtime feedback or instruction via a communication device, which could be the players mobile devices, computer(s), video, audio or any other suitable devices or infrastructure. If handheld devices, such as smart phones are used to image or scan the game objects 12, these may be coupled to a user's computer via wireless or other suitable connection. Prompts for play of game system 10 may be displayed on the screen of the handheld device, computer or the like. The game system 10 may also be designed to use video of the game play as a part of the game system 10. A video recorder, such on a handheld device or other suitable device used to play the game system 10, may be used for continuous or intermittent video capture during the game play, such as to capture the actions of the human movement, movement timing, movement through space, biometrics identity and/or facial expressions as a part of the game play. For example, a user may control one or more aspects of a game system 10 during game play using a capture device, which is designed to capture human movement and may capture a depth image of a scene. Each player may be targeted and information on each target incorporated into the computing environment, such that the computing environment may track the targeted player(s). If desired, the game system 10 could provide a rendering of an avatar associated with the targeted player(s) on a display and/or determine gestures which can be used to control one or more operations in the game system 10. The game system 10 could include a gesture recognizing engine, to continuously or intermittently scan the targeted player(s) and determine when a particular gesture has been made by the player(s) for example. This information can be used by the game system 10 to control one or more operations or actions and/or to provide feedback or gather information from the individual players which can be correlated to specific results or actions from other players for example. It should also be recognized that the reading device or system for reading the machine readable devices on game objects can be used to determine additional movements of the game objects 12, which may be a part of game play. For example, a player may cause rotation or other movement of one or more game objects 12 in two dimensional or three dimensional space, as a part of game play. The reading system may enable determination of such movements of the game objects 12 individually or in relation to one another. In examples, two dimensional and three-dimensional placement and movement such as rotation of the game objects 12 in space can be read and used as a part of game play using the game system 10.

It is also possible to implement game system 10 with players that are remote from one another, with each player contributing to the game play as if they were physically together, and using the handheld smart device, computer or the like to communicate between players. A variety of tools for interface between remote personnel on teams or otherwise can be used to allow effective implementation of the game system 10 in such an environment.

In a game system 10, various security measures can be taken such as providing the users with a password and logon name. After logging on, the users are guided through the game play. The machine readable device 14 may allow functions such as identifying each game object 12 uniquely from every other object, to interact with software located on a handheld device, computer or cloud. In one example, the game system 10 further includes a printer in communication with a controller, for printing a plurality of cards 12 for game participants, each playing card including a machine readable device 14, and for printing further information for game play as the game proceeds. For example, the game could include printing reinforcing messages based on the type of game, printing additional game objects 12 based on the results of steps during a game or the like. The invention provides a tool in a game format for entertainment of one or more individuals, and can be presented in many formats and games appealing to the individual(s). The ability to coordinate information with image analysis or the like allows leveraging of an organization's resources, provide management tools and infrastructure, evaluate performance of an individual or group, and many other applications. The invention enables, for example, assessing activity and interactions within an organization by generating and capturing data and objective metrics relating to business dynamics. The invention provides a method for analytically evaluating, managing, motivating or the like, the human capital in an organization to facilitate business functions and operation, to yield objectives, benchmarks, job descriptions, and worker-performance metrics or the like to contribute to ongoing improvement in a business. The game system 10 could be used to evaluate resources, such as identifying roles and responsibilities of employees, subcontractors, and vendors for example. The ability to provide adaptive gameplay may be useful for all kinds of different games from single player to multiplayer, and can provide a more engaging experience. Series of related games an allow dynamic response to results based on current game play, and how the player(s) react to in game events. It is also possible to allow real-time viewing of a game by others such as team leaders, managers or the like. A viewer may be provided information to help facilitate various decision making, alter or interject into the game play, or the like. The viewer may request an adjustment action (e.g., adding another or different game objects 12, or the like.

The invention provides a game system 10 that can facilitate achieving consensus and teambuilding within a company; monitoring and measuring the company's progress in achieving objectives; making reasoned business decisions; reinforcing or adjusting the company's activities; understanding changes in an industry or business practices, or for entertainment among other things. The supporting platform 30 may utilize and/or interface with a user interface, a display; and include a processor coupled to computer-readable storage medium having stored thereon computer-executable instructions for a software application for use in game systems 10 and game play. The program code on computer-readable storage medium creates the means for causing the computer to perform the various operations of the present invention. The computer program code, whether stored in a storage medium loaded into and/or executed by a processor, or transmitted over a transmission medium, such as over electrical wiring or cabling, through fiber optics, or wirelessly, when loaded into and executed by a processor, becomes a part of the game system 10 of the invention. Program code embodied on a computer readable medium may be transmitted using any appropriate medium, including but not limited to wireless, wireline, optical fiber cable, RF, etc., or any suitable combination of the foregoing.

In another aspect of the invention, there may be provided a supporting system 40, such as a game system container, such as shown in FIG. 4A. In this example, the game system 10 may include at least a plurality of game objects 12, such as a deck of game cards, which can be stored in supporting system 40. As a part of the game play may include reading game objects and/or players or gestures as previously described, the supporting system 40 allows a player to mount a reading device 50, such as a typical handheld device (i.e., smart phone, tablet or the like) to allow imaging and processing of machine readable devices 14 on played game objects 12 and/or game participants, as seen in FIG. 4B. The container 40 may include a supporting and positioning structure 42 on the interior of container 40 that may be accessed via a top opening 44. The supporting and positioning structure 42 in conjunction with a side of the container 40 allows the smart phone 50 to be propped in one or more positions above the playing surface to read or image game objects 12 placed on a surface and/or image or video game participants for example. The container box 40 of this example provides a platform for holding and suspending a mobile phone 50 or other device above the area of play. This would enable reading of the machine readable devices 14 on game objects 12 without users having to manually suspend the phone 50 (or the like) themselves. The device 50 of this example includes a camera 52 to image and/or video the game objects 12 and/or participants. The container 40 in this example serves as an accessory which simplifies the storage of game objects while allowing support of a reading device to capture images/videos, but other suitable supporting system 40 and/or structure 42 may be provided. In game play, one or more users may make a hand gesture or place a game object 12 to capture the image or video for processing for example, or other suitable approach to reading the game object(s) and/or human movements during game play may be used. The reading device 50 may also be used for continuous video capture of the game play such as previously described. The actions of the human movement timing, movement through space, biometrics identity and facial expressions into the embodiment of the patent as that they inform the intent and feedback from the individual which can be correlated to specific operations, actions and/or results from other players for example.

The corresponding structures, materials, acts, and equivalents of all systems or devices, or means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The examples were chosen and described in order to best explain the principles of the invention and some practical applications, and to enable those of ordinary skill in the art to understand the invention and understand that various modifications would be suited to the particular use or application contemplated.

What is claimed is:

1. A game system comprising:
a plurality of game objects, each game object including a machine readable device provided therewith; and
at least one starter/control game object including a machine readable device provided therewith.

2. The system of claim 1, wherein each game object is uniquely identifiable using the machine readable device.

3. The system of claim 1, further comprising a processor wherein the machine readable device is a device which can be imaged and the image processed by the processor to trigger some action or response in the game system.

4. The system of claim 1, wherein at least one starter/control object allows a player to register and identify the type of game to be played.

5. The system of claim 1, wherein the at least one of the game objects or at least one starter/control object allows triggering a computer generated narrator voice for guiding the game play.

6. The system of claim 1, wherein the at least one starter/control object launches a predetermined game from a plurality of games and/or game types and registers a unique set of game objects to each player.

7. The system of claim 1, wherein the game system includes a memory, and a player profile and/or identification that is linked to play of a game by that player and acquiring and storing data related to the played games.

8. The system of claim 1, further comprising a platform of game system information that is accessed upon initiation of a game by the reading the machine readable device associated with the at least one starter/control object.

9. The system of claim 8, wherein the platform provides the ability for a user to customize a game system for a particular user or application.

10. The system of claim 8, wherein the platform provides the user the ability to print the game objects and machine readable devices.

11. The system of claim 8, wherein the platform provides a plurality of pre-created games types.

12. The system of claim 8, wherein the platform provides the ability for the user to create a game and produce the game objects and the machine readable device on the game objects.

13. The system of claim 8, wherein the platform provides storage for information generated during play of the game.

14. The system of claim 8, wherein the platform provides the ability for a user to customize a game system for a particular user or application.

15. The system of claim 1, wherein a plurality of machine readable devices associated with a plurality of game objects can be read simultaneously.

16. The system of claim 15, wherein the location of the plurality of machine readable devices relative to one another is used in the game system.

17. The game system of claim 1, designed for personality assessment, wherein the game objects include at least one of questions directed to the personality of one or more people, answers directed to the personality of one or more people, personality traits, strengths and weaknesses associated with one or more people or combinations thereof.

18. The game system of claim 1, designed for business planning and performance, comprising:
providing a plurality of game objects with questions, answers, attributes, characteristics or combinations thereof that relate to evaluating a set of business functions performed by a business entity selected from the group comprising operations, finance, personnel, innovation team performance and marketing, wherein the game objects are used by a plurality of players to respond to game actions or results, and the machine readable devices on played game objects are read during play of a game to provide results relating to desired objectives for each business function.

19. The game system of claim 1, further comprising a mounting structure for mounting of a reading device in a position to read the machine readable device on one or more game objects.

20. A game system comprising:
a plurality of game objects, each game object including at least one machine readable device provided therewith;
at least one starter/control game object including at least one machine readable device provided therewith, and
a processing system to receive information from reading the at least one machine readable device on at least one game object and perform at least one operation, action, communication or combinations thereof during play of the game system.
